(19) United States
(12) Patent Application Publication
(10) Pub. No.: US 2002/0121246 A1
(43) Pub. Date: Sep. 5, 2002

(54) Suspendable animal nourishment means

(76) Inventor: Mark L. Harman, Glendale, AZ (US)

Correspondence Address: Christopher J. Whewell, Western Patent Group, 6020 Tonkowa Trail, Georgetown, TX, 78628, US

(21) Appl. No.: 09/798,388

(22) Filed: Mar. 5, 2001

(51) Int. Cl. A01K 5/01

(52) U.S. Cl. 119/61

(57) ABSTRACT

Provided herein are means by which nourishment such as food and/or water may be placed in a suspended location which is accessible to animals, but not accessible by ground borne pests such as ants, roaches, and the like. By keeping foodstuffs away from such pests, insect populations may be minimized and ingestion of insects contained within the food by an animal is eliminated, along with health factors associated therewith. By elevating the food of an animal in the case of household pets, a lessened amount of air is swallowed by the animal during a feeding exercise, which results in better digestion and less discomfort.

### TECHNICAL FIELD

This invention relates to means for providing food and other nourishment to animals. More particularly, it relates to a means for providing such nourishment to animals which is inaccessible by ground-based insect attack, and which results in lessened indigestion by the feeding animal by virtue of less air being swallowed along with the food owing to the alteration of the animal's posture during an eating exercise which arises from the elevation of the foodstuff.

### BACKGROUND

Since the earliest times of animal domestication, various means have been devised to contain food nourishments, the most popular of which undoubtedly comprises a receptacle such as a simple bowl. Bowls, dishes, and the like have been found desirable since they provide for the containment of the foodstuff and offer a convenient means by which an overseer may replenish the food at a given time, by either refilling the receptacle at a selected stationary location, or by removing the receptacle to a food source, filling the receptacle, and placing it at a desired location. The prior art has attempted to provide practical solutions to problems associated with the feeding of animals.

U.S. Pat. No. 5,111,771 teaches an exercise and amusement device for a pet, comprising in combination a cylindrical resilient body member suitable for providing resistance against chewing actions by the pet, the resilient body member comprising a flexible tube. The inside of the flexible tube is stuffed with a foam. There is a bottom panel having an aperture covering an open bottom end of the flexible tube. There is a resilient suspending means for hanging the body member from above at a predetermined height to permit the body member to swing freely when struck, and for providing elastic resistance to pulling of the body member by the pet, the resilient suspending means including a tether passing through the body member and the aperture and knotted at a bottom side thereof to prevent the tether from passing back through the aperture; and a removable covering means, for covering the body member.

U.S. Pat. No. 5,564,362 discloses an animal feeder comprising a water dish, a food dish, and a support means for supporting and suspending the food dish above ground and laterally offset from a position over the water dish. The support means is coupled to the food dish and the water dish. The water dish and the food dish each have a wall closely positioned relative to each other. The wall of the water dish extends partially around the wall of the food dish but separate therefrom to stabilize the feeder against tipping when the water dish has water in it even though the food dish is suspended above the ground in a laterally offset position.

U.S. Pat. No. 5,165,365 sets forth an ant proof pet feeder apparatus that includes a a base member which has a central axis and a base tube fixedly mounted to the base member in a coaxially aligned relationship and extending upwardly therefrom. There is a first support tube which is slidably mounted on the base tube and telescopingly receives the base tube within a lower terminal end of the first support tube. The first support tube includes a first support tube upper terminal end. There is a torroidal fluid container coaxially mounted on the first support tube which is spaced from the first support tube upper terminal end. A second support tube telescopingly receives the first support tube and secures the fluid container to the first support tube, and the second support tube further includes a second support tube upper terminal end. There is a feed dish container, which includes a cylindrical socket fixedly mounted to a bottom surface of the feed dish container and receives the second support tube upper terminal end therewithin. The cylindrical socket is coaxially aligned relative to the central axis. The first support tube includes an abutment flange orthogonally mounted to the first support tube about an exterior surface thereof and spaced below the first support upper terminal end, with the torroidal fluid container mounted upon the abutment flange, and the first support tube is defined as having an external first diameter, and the torroidal fluid container includes a central opening defined by a diameter equal to the first diameter. The torroidal fluid container includes an inner cylindrical wall spaced below the first support tube upper terminal end, and the second support tube includes a second support tube lower terminal end. The second support tube lower terminal end is arranged in abutment with the fluid container inner cylindrical wall.

By far, the most common items in use for providing foodstuffs to animals today is the simple bowl-shaped receptacle, a common dog dish being exemplary. However, during the use of the common dog dish, a foodstuff is placed in the bowl, and the bowl is placed on the ground in a location selected by the overseer or pet owner. Insects such as ants, roaches, and the like are equipped with keen senses which enable them to rapidly detect and seek out a food source. This is particularly true in the case of mixed grains, and especially when such grains inherently contain various sugars, or are treated with flavor enhancers to be more palatable to the animals to be fed. Red ants and fire ants are particularly troublesome, since they can enter into the interstices between individual particles of food undetected. Such undetected ants are prone to being taken in the mouths of the feeding animal, resulting in open wounds in the animal's mouth from the bites of such insects, which can readily lead to infection.

Further, when using a dog dish according to conventional wisdom, the posture of the animal during feeding is one in which the animal's neck is generally angled downwards towards the bowl, which permits air to be swallowed with the food, particularly in the case of animals which tend to eat rapidly such as very hungry dogs. Ingested air is undesirable for the animal because of intestinal discomfort it produces and it is undesirable for pet owners because of malodorous gas the animal may be caused to expel in one's living quarters.

Thus, if a means were devised for containing animal feeds and the like which precluded insects from having an additional food source, the total insect population in an area where animals are housed could be diminished. Further, if a means were devised for containing animal feeds which precluded biting insects from entering the interstices between individual food particles undetected, bites to the interior body of animals feeding from such a device would be eliminated. Further, if a means were devised for containing animal feeds and the like which altered the posture of a feeding animal so as to reduce or eliminate the amount of air ingested along with a food during feeding, the animal would be prone to suffer less abdominal discomfort, and a pet owner would appreciate a decreased volume of flatulated gases. The present invention provides means which provide these and other benefits and which will become apparent to one of skill in the art after reading this specification.

### SUMMARY OF THE INVENTION

The present invention provides in one form a device useful for providing nourishment to animals which comprises a bowl portion having a floor portion and a rim portion. There are a plurality of secondary support means, wherein each of the secondary support means has a first end portion and a second end portion. The first end portion of each of the secondary support means is connected to the rim portion of the bowl portion, and each of the second end portions of the plurality of secondary support means are connected to one another, so as to form a junction point. There is a primary support means which has a first end portion and a second end portion. The first end portion of the primary support means is connected to the junction point, and the second end portion of the primary support means is adapted to be connected to a stationary anchor.

In another embodiment, the present invention provides a device useful for providing nourishment to animals which comprises a bowl-receiving portion which is adapted to receive a bowl portion. There are a plurality of secondary support means, which each secondary support means has a first end portion and a second end portion. The first end portion of each of the secondary support means is connected to the bowl-receiving portion, and each of the second end portions of the plurality of secondary support means are connected to one another, so as to form a junction point. There is a primary support means, which has a first end portion and a second end portion, wherein the first end portion of the primary support means is connected to the junction point. The second end portion of the primary support means is adapted to be connected to a stationary anchor, so as to provide the bowl-receiving portion as being suspended in the air. Finally, there is a bowl portion disposed within the bowl-receiving portion.

Another embodiment of the present invention provides a device useful for providing nourishment to animals which comprises a bowl portion having a floor portion and a rim portion, wherein the bowl portion further includes a protrusion extending upwardly from the floor portion. The protrusion has a first end portion which is in contact with the floor portion and a free second end portion. There is a primary support means, which has a first end portion and a second end portion. The first end portion of the primary support means is connected to the free second end of the protrusion, and the second end portion of the primary support means is adapted to be connected to a stationary anchor. The protrusion is of sufficient length to enable the connection of the primary support means to occur at a point which is disposed a distance of at least one-half the height measurement from the floor of the bowl to its rim portion.

### DETAILED DESCRIPTION

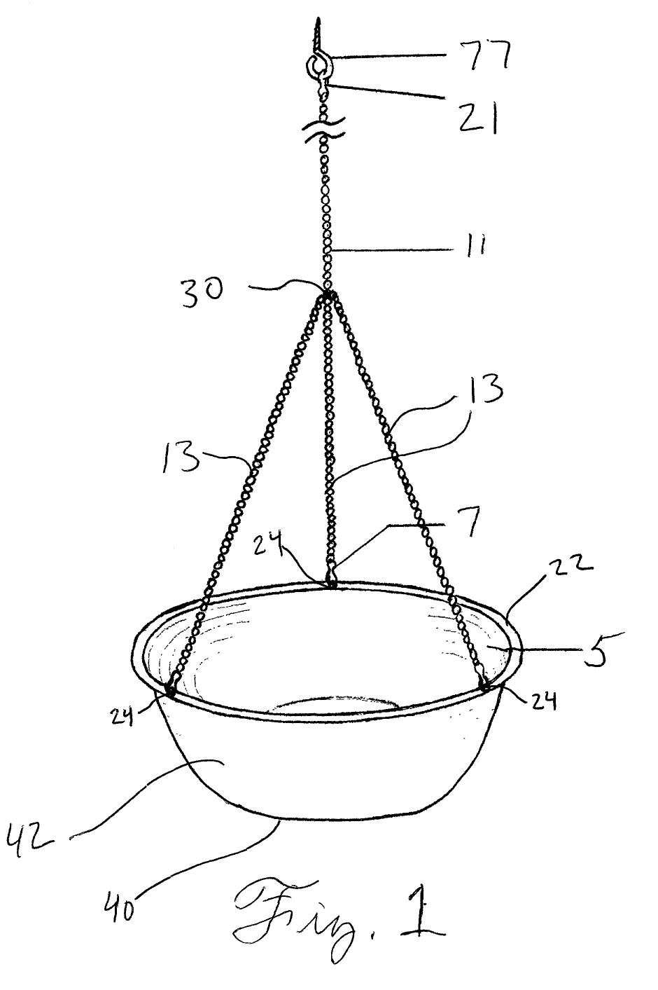

Referring to the drawings and initially to FIG. 1 there is shown a means for providing nourishment to an animal according to the invention. In this figure, bowl 5 comprises a rim portion 22, a floor portion 40, and a wall portion 42. It is possible that the floor portion and the wall portion may not be distinct from one another, as in cases where the bowl portion is completely curved and comprises a semi-circle. The rim portion 22, which is the upper edge of the bowl, includes a plurality of holes 24 disposed therethrough which are suitable for being mechanically connected to a secondary support means as described hereafter. It is preferred that the holes 24 are located as close to the top edge of the rim portion as possible, but not so close as to only leave an insufficiently strong amount of stock from which the bowl is comprised to remain between the outer periphery of the hole and the outer edge of the rim, which would compromise the integrity of the bowl portion. The holes may be disposed at any points along the periphery of the rim portion, however, it is most preferred that the holes are evenly-spaced about the rim. That is, when a means according to the invention is to include two secondary support means, it is preferred that the rim portion comprises two holes which are spaced on opposite sides of the rim on the bowl portion. When a means according to the invention is to include three secondary support means, it is preferred that the rim portion comprises three holes which are spaced on about ⅓ of the periphery of the rim on the bowl portion, which in the case of a circular bowl is 120 degrees from one another.

In mechanical linkage with each of the holes is a secondary support means 13, which is preferably a chain made from metal or a metallic alloy, although other functionally equivalent means may be used herein as the secondary support means, including ropes, yarns, twine, steel rods, plastic rods, wooden dowels, cable(s), etc. A secondary support means according to the invention has a first end portion which is attached to the bowl portion, and a second end portion. The means of attachment of the secondary support means to a hole in the rim portion of the bowl may be any fastening means known to those skilled in the art, including twisted wire, c-shaped hooks, s-shaped hooks, split rings, welds, spring clips, screws, rivets, etc. (hereinafter collectively referred to as “connective means”). However, it is most preferred that each of the connective means employed be of a type which allows for the convenient detachment of the bowl from each of the secondary support means, such as a hook with a springed closure (i.e., a “spring clip”).

When a plurality of secondary support means are employed according to the invention, their second end portions preferably join at an junction point 30, using a conventional connective means. The invention further comprises is a primary support means 11 which has a first end portion and a second end portion. The first end portion of the primary support means 11 is attached simultaneously to each of the plurality of secondary support means 13 at their junction point. The second end portion of the primary support means is attached to a stationary anchor 77, which in one preferred form of the invention is a screw-in hook, as such are well known in the art, which is fixedly connected to a stationary object such as a tree limb, roof, ceiling, existing pet housing, etc. However, functional equivalents of the stationary anchor include other types of hooks such as s-hooks, loops, hanging twines, etc. and virtually any ware from which a chain may be hung. Functionally, the primary support means 11 may be selected to be of sufficient length that it may itself function as a stationary anchor, in those cases where the primary support means is looped around an object such as a saw horse, tree branch or other horizontal construct. Thus, in order to use the invention according to this embodiment, one first selects a location from which the assembly as a whole is intended to be hanged. A stationary anchor is selected and affixed to an overhead location. Next, the end of the primary support means which is not connected to the junction point is attached to the stationary anchor, and the bowl portion is attached to the end portion of each secondary support which is not connected to the junction point. Then, a food item may be charged to the bowl and the animal(s) to be fed are admitted to the area.

The distance from which the rim portion of the bowl is disposed with respect to the ground may be readily adjusted to a desired level by altering the length of the primary support means or secondary support means, although alteration of the length of the primary support means is the preferred method of adjustment. This is a simple matter when chains are employed as the primary and/or secondary support means.

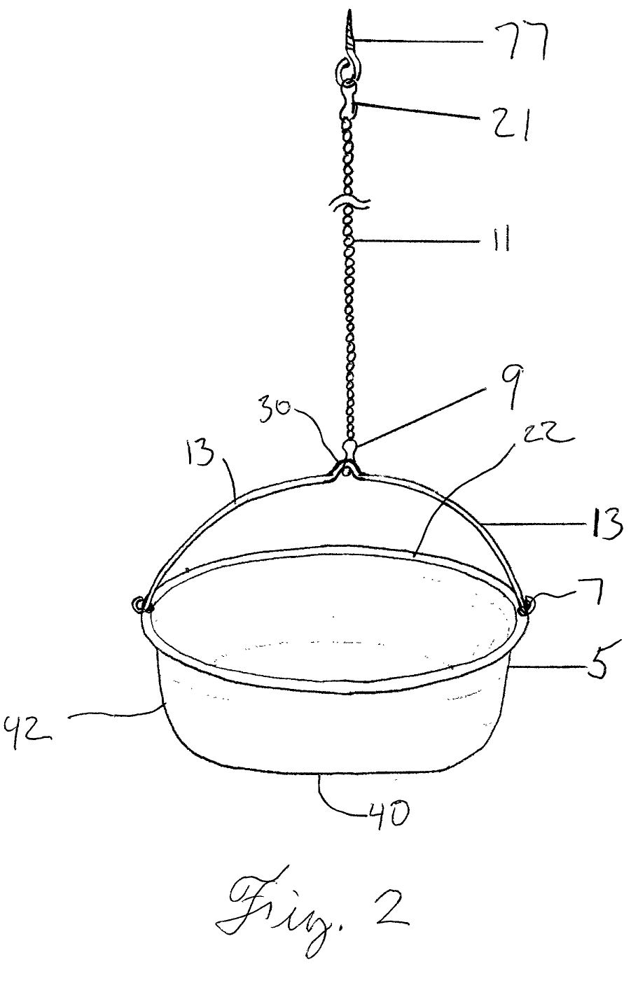

FIG. 2 shows an alternate mode of the embodiment of FIG. 1, in which the there are two secondary support means 13, each of which are connected at their first end portions to the rim portion 22 of the bowl 5 at locations 180 degrees apart from one another along the rim. The second end portions of the secondary support means are connected to one another at the junction point 30, and at the junction point is also connected the primary support means 11 by way of spring clip 9. This arrangement is particularly convenient, as the bowl portion may be removed from the primary support means 11 merely by disconnecting the spring clip 9 and using the connected secondary support means as a handle. This greatly simplifies the operation of cleaning and re-filling the bowl.

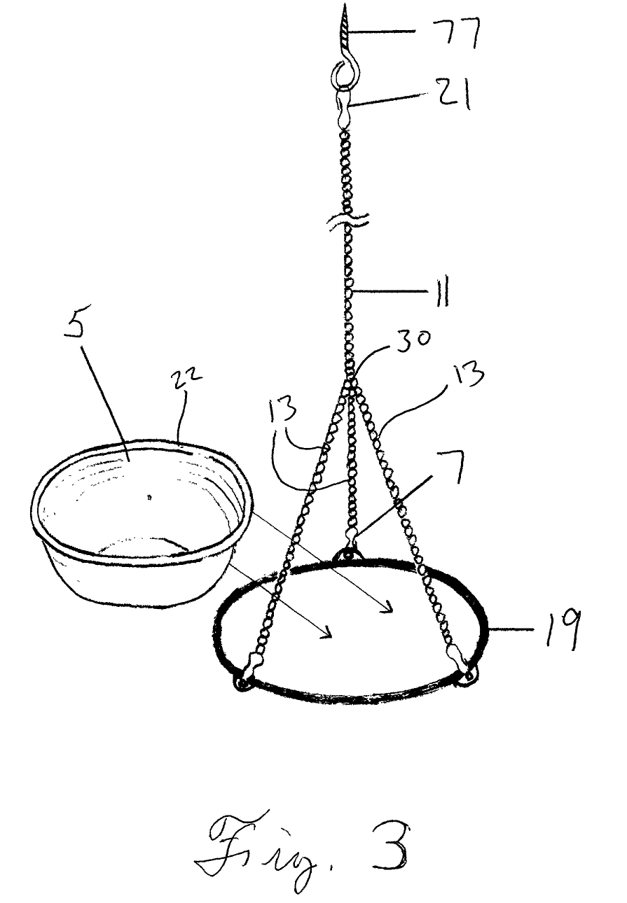

In FIG. 3 is shown a preferred form of the invention in which the bowl portion of the embodiment depicted in FIG. 1 is replaced by a retaining portion 19, which in the embodiment shown is circular, although this principle is readily applied to other geometries as well. In this embodiment, there are secondary support means 13, each of which includes a first end portion and a second end portion. The first end portion of the secondary support means are attached to the retaining portion as described above with reference to FIG. 1, and the second end portions of the secondary support means are joined to one another at an junction point 30. At the junction point 30 is attached the first end of a primary support means, whose second end is secured to a stationary anchor 77 which is fixedly connected to a stationary object such as a tree limb, roof, etc. In practice in this embodiment, a location for the feeding means is selected, and the stationary anchor is secured into position. Next, the first end of each of the secondary support means are attached to the retaining portion, and the second ends of the secondary support means 13 are connected at a junction point 30. The first end of the primary support means is connected to the junction point 30, and the second end portion of the primary support means is connected to the stationary anchor, so as to provide the retaining portion 19 as being suspended in air, its height above ground being determined by the user as before. The diameter of the retaining portion is selected to be sufficient to support the bowl portion 5 by the rim 22, thus enabling the bowl 5 to be inserted into the suspended retaining portion 19 and held in place by virtue of the overlap of the rim portion 22 of the bowl 5 over the outer circumference of the retaining portion 19. Thus, the diameter of the retaining portion 19 is selected to be just slightly smaller than the diameter of the overhanging rim 22, when the bowl is round. This embodiment has the advantage that the bowl may be simply pulled out of the assembly as a whole for refilling and/or cleaning purposes.

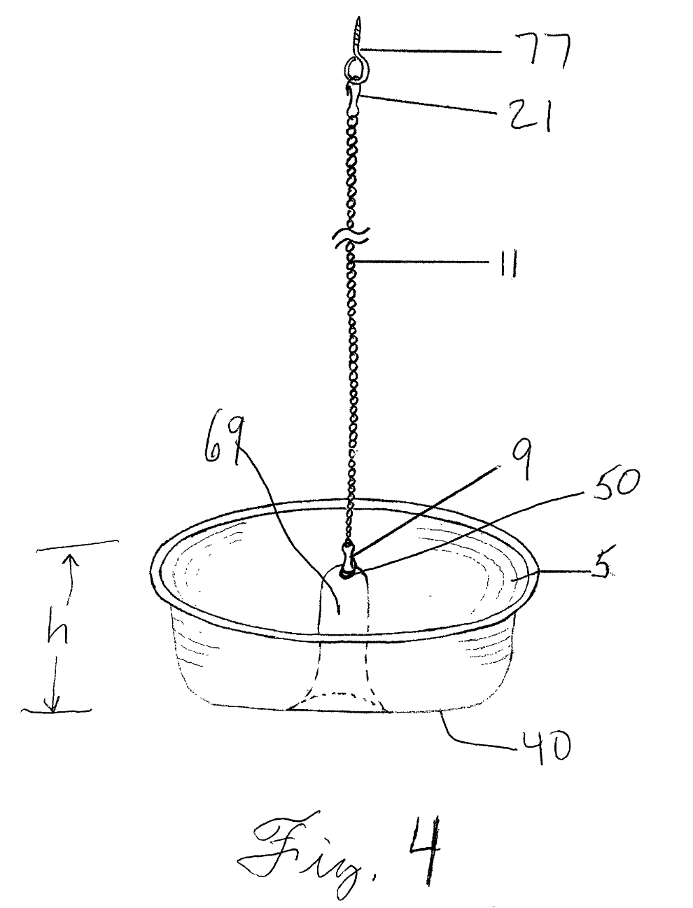

In FIG. 4 is shown a further embodiment of the invention in which the primary support means is attached directly to the bowl portion. This embodiment makes use of a specially configured bowl 5 having in the center of its interior a location at which the primary support means may be directly connected, as such connective means is described above. In such an embodiment, the center of the floor portion includes a protrusion 69, which may be “cast-in” to the bowl during its manufacture, in which case it is an integral part of a single construct. Alternately, such a protrusion 69 may be a stand alone element which is subsequently affixed to the floor portion 40 of the bowl 5 by conventional connective means. It is not desirable to connect the primary support means 11 directly to the floor portion 40 of the bowl 5, because such a configuration lacks the stability of the embodiment when a central protrusion 69 is used. It is preferred that the protrusion 69 be of sufficient length to enable the connection of the primary support means 11 to occur at a point 50 which is disposed a distance of at least one-half the height measurement h from the floor portion, wherein the height measurement h is defined as being the distance from the lowermost point on the floor portion 40 to the rim portion of the bowl 5. The end of the primary support means 11 which is connected to the stationary anchor 77 is preferably connected thereto using a spring clip 21.

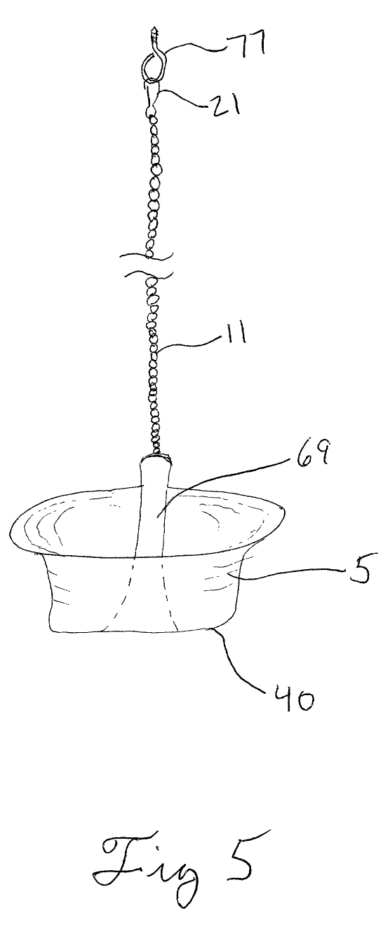

A further example of this embodiment having even greater stability is shown in FIG. 5, in which the contact point of the primary support means 11 with the protrusion 69 occurs above the rim of the bowl 5. In addition to increased stability, this embodiment also provides for the ready service of the bowl, which may be removed from the primary support means 11 by disconnecting the spring clip 9.

Although the present invention is especially well suited for containing foodstuffs or water for domestic animals such as dogs and cats, a means according to the invention is equally useful for other animals such as hogs, cattle, and other livestock, and may find preferable employment in zoos, kennels and other large-scale animal housing facilities owing to the increased overall cleanliness to the area conferred by use of a means according to the invention. Indeed, by removing one possible food source for insects, the total insect population in a given area inhabited by animals is diminished. Since many insects are known to carry various diseased, the benefits of the present invention extend to disease prevention.

Further, by providing discrete sections within a given bowl portion used in accordance with the present invention, by means of partitions in the interior of the bowl portion, it is possible to provide a single container means for both solid and liquid nourishment which is maintained above ground and hence out of reach of the effects of ground-borne pests.

According to the various forms of the invention, the bowl portion may take on any shape as viewed from above, including without limitation square, rectangular, circular, oval, etc.; however, it is preferred that the bowl portion is circular. Further, the material of construction of the bowl portion 5 may be varied, including various polymers, both thermoplastic and thermoset, stainless steel, rubber, wood, or virtually any material. It is most preferred that the bowl portion be comprised of a material selected from the group consisting of: stainless steel or thermoplastic resins.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Such modifications may include without limitation changing the size or shape of the various components of the invention to accommodate the volumetric food or water requirements of animals intended to be nourished, materials of construction, etc. Accordingly, the presently disclosed invention is intended to cover all such modifications and alterations, and is limited only by the scope of the claims which follow.

I claim:

1) A device useful for providing nourishment to animals which comprises:
a) a bowl portion having a floor portion and a rim portion;
b) a plurality of secondary support means, wherein each of said secondary support means has a first end portion and a second end portion, wherein the first end portion of each of said secondary support means is connected to the rim portion of said bowl portion, and wherein each of the second end portions of said plurality of secondary support means are connected to one another, so as to form a junction point; and
c) a primary support means, wherein said primary support means has a first end portion and a second end portion, and wherein said first end portion of said primary support means is connected to said junction point, and wherein said second end portion of said primary support means is adapted to be connected to a stationary anchor.

2) A device according to claim 1 further comprising:
d) a stationary anchor, wherein said second end portion of said primary support means is connected to said stationary anchor.

3) A device according to claim 2 wherein said stationary anchor is securely affixed to an overhead location selected from the group consisting of: a tree limb, a roof, a horizontal post, or a horizontal beam.

4) A device according to claim 1 wherein said plurality of secondary support means comprises any number of secondary support means between two and six.

5) A device according to claim 1 wherein at least one of said primary support means and said secondary support means are comprised of a construction selected from the group consisting of: chains, wires, ropes, twines, yarns, and strings.

6) A device according to claim 1 wherein said secondary support means is connected to said rim portion of said bowl by means of a hook portion disposed on the first end portion of said secondary support means.

7) A device according to claim 1 wherein said primary support means further includes a hook portion disposed at the second end portion of said primary support means.

8) A device according to claim 3 wherein said primary support means is connected to said stationary anchor by means of a hook portion disposed on the second end portion of said primary support means.

9) A device useful for providing nourishment to animals which comprises:
a) a bowl-receiving portion which is adapted to receive a bowl portion;
b) a plurality of secondary support means, wherein each of said secondary support means has a first end portion and a second end portion, wherein the first end portion of each of said secondary support means is connected to said bowl-receiving portion, and wherein each of the second end portions of said plurality of secondary support means are connected to one another, so as to form a junction point;
c) a primary support means, wherein said primary support means has a first end portion and a second end portion, and wherein said first end portion of said primary support means is connected to said junction point, and wherein said second end portion of said primary support means is adapted to be connected to a stationary anchor, so as to provide said bowl-receiving portion as being suspended in the air; and
d) a bowl portion disposed within said bowl-receiving portion.

10) A device according to claim 9 further comprising:
d) a stationary anchor, wherein said second end portion of said primary support means is connected to said stationary anchor.

11) A device according to claim 10 wherein said stationary anchor is securely affixed to an overhead location selected from the group consisting of: a tree limb, a roof, a horizontal post, or a horizontal beam.

12) A device according to claim 9 wherein said plurality of secondary support means comprises any number of secondary support means between two and six.

13) A device according to claim 9 wherein at least one of said primary support means and said secondary support means are comprised of a construction selected from the group consisting of: chains, wires, ropes, twines, yarns, and strings.

14) A device according to claim 9 wherein said secondary support means is connected to said rim portion of said bowl by means of a hook portion disposed on the first end portion of said secondary support means.

15) A device according to claim 9 wherein said primary support means further includes a hook portion disposed at the second end portion of said primary support means.

16) A device according to claim 11 wherein said primary support means is connected to said stationary anchor by means of a hook portion disposed on the second end portion of said primary support means.

17) A device useful for providing nourishment to animals which comprises:
a) a bowl portion having a floor portion and a rim portion, and wherein said bowl portion further includes a protrusion extending upwardly from said floor portion, said protrusion having a first end portion which is in contact with said floor portion and a free second end portion;
b) a primary support means, wherein said primary support means has a first end portion and a second end portion, and wherein said first end portion of said primary support means is connected to the free second end of said protrusion, and wherein said second end portion of said primary support means is adapted to be connected to a stationary anchor,
wherein the protrusion is of sufficient length to enable the connection of the primary support means to occur at a point which is disposed a distance of at least one-half the height measurement from the floor of the bowl to its rim portion.

18) A device according to claim 17 further comprising:
c) a stationary anchor, wherein said second end portion of said primary support means is connected to said stationary anchor.

19) A device according to claim 18 wherein said stationary anchor is securely affixed to an overhead location selected from the group consisting of: a tree limb, a roof, a horizontal post, or a horizontal beam.

20) A device according to claim 17 wherein at least one of said primary support means and said secondary support means are comprised of a construction selected from the group consisting of: chains, wires, ropes, twines, yarns, and strings.
